(19) United States
(12) Patent Application Publication
(10) Pub. No.: US 2003/0217703 A1
(43) Pub. Date: Nov. 27, 2003

(54) Pet accessory

(76) Inventor: Deborah Kiss, Toronto, CA (US)

Correspondence Address: Mark B. Eisen, Dimock Stratton Clarizio LLP, 20 Queen Street West, Suite 3202, Box 102, Toronto, ON, M5H3R3, CA

(21) Appl. No.: 10/153,779

(22) Filed: May 24, 2002

(51) Int. Cl. A62B 35/00

(52) U.S. Cl. 119/863

(57) ABSTRACT

A pet accessory is provided which allows for easy disassembly or removal of a collar without requiring the user to detach identification tags or the like from the collar. The collar comprises a first portion and a second portion which are releasably attached to each other to form a loop to pass around a pet's neck. The first portion preferably provides means for adjusting the overall length of the accessory. The second portion preferably provides means for attaching identification tags, vaccination tags, and the like.

### FIELD OF THE INVENTION

The present invention relates generally to the field of pet accessories, and more specifically to collars for domestic pets.

### BACKGROUND OF THE INVENTION

Collars are used for many domestic animals kept as pets, for both functional and decorative purposes. Collars are typically provided with findings, such as metal D-rings or circular rings, for affixing licence tags, vaccination tags, or other identification on a permanent basis, and also for temporary attachment of a clip-on leash or restraint. Such collars are composed of a strip of material such as leather, nylon, cotton or synthetic webbing, chain, or other fabric or cording. They are fastened at a single point around the animal's neck using a clip or buckle, the male and female portions of which are attached permanently to the material. Some collars provide a slide for adjusting the overall length of the collar so that it fits comfortably and safely around the animal's neck; other collars allow for minor adjustments in length by providing a series of holes for the buckle prong if the collar is fastened using a buckle. Pet collars are sold in bright colours or designs to appeal to the pet owner's aesthetic sense.

However, such pet collars that are presently known in the art have significant drawbacks. Collars can become soiled with wear, and it becomes desirable to change or clean them. However, when the collar is exchanged for a new one, all the licence tags and other identification must be removed from the D-ring fixed to the old collar; similar to attaching a key to a key ring, it is difficult to force the ring attachment of a licence tag onto the D-ring. Many pet owners use a knife, screwdriver or fingernail to aid the process, which leads to injury if the implement slips, or to badly broken fingernails. If the collar is removed for cleaning, then the pet must go without a collar, or wear a collar without the appropriate licence tags and identification. If the pet is lost when not wearing identification, there is an increased risk that the pet will not be returned to its owner.

Furthermore, because of the difficulty inherent in the removal and transfer of licence tags, pet owners are discouraged from purchasing new and more attractive collars, despite the availability of new styles and colours of collars on the market.

### SUMMARY OF THE INVENTION

The invention provides a two-piece collar having a strap and a removable centre portion, to which licence tags or other accessories may be mounted. The centre portion is provided with two connectors which cooperate with connecting pieces near either end of the strap to form a complete collar. The invention thus provides a collar having interchangeable straps to facilitate exchange of collars.

### BRIEF DESCRIPTION OF THE DRAWINGS

In drawings which illustrate by way of example only a preferred embodiment of the invention,

FIG. 1 is a perspective view of a preferred embodiment of the pet accessory in an open position.

FIG. 2 is a perspective view of a further embodiment of the fastening means of the pet accessory.

### DETAILED DESCRIPTION OF THE INVENTION

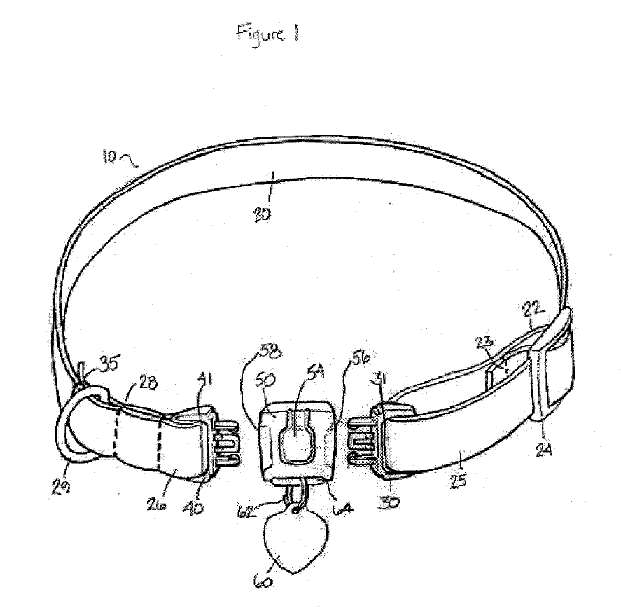

Referring to FIG. 1, a preferred embodiment of the present invention is shown. The accessory 10 is shown in an “open” position, where the centre portion 50 is disconnected from either connector 30, 40 mounted on the collar portion 20.

The strap 20 is composed of a length of material, preferably a webbing or leather fabric. The ends of the collar portion 20 are fixed to the connectors 30, 40 respectively. Where the connectors 30, 40 are provided with apertures 31, 41, the ends of webbing of the collar portion 20 may be passed through the apertures 31, 41, and fixed in place to hold the connectors 30, 40 securely. Preferably, as shown in FIG. 1, where the material of the collar portion 20 allows, the connectors 30, 40 may be securely fastened to the collar portion 20 by forming loops of webbing 25, 26 which may then be stitched or otherwise fastened in place.

The collar portion 20 may optionally provide a fixture for temporarily securing a leash or other restraint. A ring 29 may be fixed to the collar portion 20. The ring 29 is preferably constructed of metal (welded or non-welded) or strong plastic. Again, where the material of the collar portion 20 allows, the ring 29 may be fixed in place by rows of stitching 28, 35 between two layers of the strap 20, folded as shown in FIG. 1 to form a loop 41 on which the connector 40 is mounted.

The collar portion 20 may also optionally provide means for adjusting the overall length of the accessory 10 by providing a slide 24 on the collar portion 20. The slide 24 preferably is an open frame with a central rung. The collar band end 22 is passed through the slide 24, under the frame and over the middle rung, then pulled through the slide 24 and the connector 30, then looped back around to the underside of the slide 24 where the band end 22 is slipped over the middle rung of the slide 24 and secured via a line of stitching 23. The middle rung of the slide 24 may be recessed or non-recessed. The connectors 30, 40 may be fixed to the strap 20 by other means; for example, the connectors 30, 40 may be provided with a crimping end which may be crimped onto the ends of the strap 20, thus eliminating the use of loops in the material of the strap 20 for fixing the connectors 30, 40 thereto.

The connectors 30, 40 are preferably fixed to the collar band 20 by looping the collar band end 22 through the hollow portion of one side of the connector 30, 40. The connectors 30, 40 may be made of a variety of materials including plastic or metal, and house either a male or female connection end which can be attached to the centre portion's 50 female (if connector 30, 40 is male) or male (if connector 30, 40 is female) end.

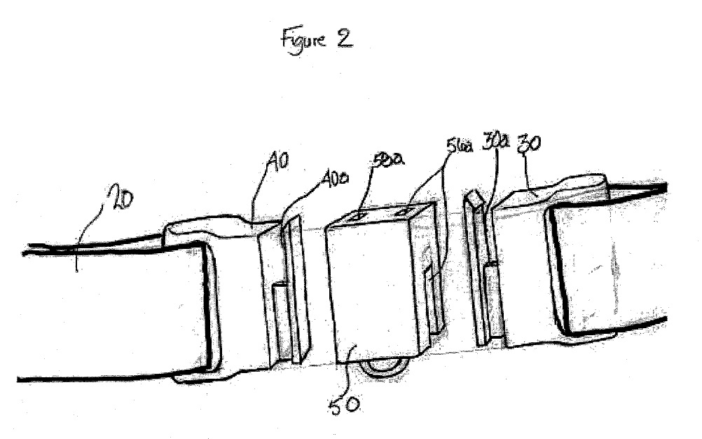

The centre portion 50 has either a male or female connector 56, 58 on either side (shown in phantom on FIG. 1), which releasably attaches to the connectors 30, 40 respectively on the collar band 20. The centre portion 50 has an aperture 64 on the bottom side. The aperture 64 allows for third party attachments 62, 60. In the preferred embodiment shown in FIG. 1, the connectors 30, 40 are attached to the connectors 56, 58 on centre portion 50 and are released from centre portion 50 using the release button 54, using a mechanism that is known in snap or buckle fasteners. The release mechanism may optionally be located instead on the connectors 30, 40. In another embodiment, shown in FIG. 2, the connecting means may be in a hook-and-receptacle form, as shown in FIG. 2. The connectors 30, 40 are provided with cavities 30a, 40a, which cooperate with the hooks 56a, 58a provided on the centre portion 50 to releasably attach the collar 20.

To put the collar 10 onto a pet (not shown), preferably the attachments 62, 60 are fixed to the centre portion 50, then one connector 56 or 58 of the centre portion 50 is attached to one of the connectors 30, 40 on the collar band 20. The collar 10 is then placed around the pet's neck and the remaining connector 58 or 56 is attached to the centre portion 50.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A collar comprising:
a strap with a first and a second end, and a first and second connector mounted to the first and second ends, respectively; and
a centre portion comprising a first and second receptacle for releasably fixing the first and second connectors, respectively.

2. The collar of claim 1 wherein the centre portion comprises a means for fixing a third-party attachment thereto.

3. The collar of claim 2 wherein the strap comprises means for adjusting the overall length of the strap.

4. A two-piece collar comprising:
a first portion having a length;
a second portion;
means for releasably fixing said first portion to said second portion to form a loop.

5. The collar of claim 4 wherein either the first portion or the second portion comprises a means for fixing a third-party attachment thereto.

6. The collar of claim 5 wherein first portion comprises means for adjusting the overall length of the first portion.

7. A collar comprising:
a first, elongated portion comprising first attachment means at either end;
a second portion comprising two second attachment means for releasably attaching the first attachment means of the first, elongated portion, the second portion further comprising a means for fixing a third-party attachment.

8. The collar of claim 7 wherein the first, elongated portion comprises means for adjusting its length.

9. The collar of claim 8 wherein the third-party attachment is a tag.
